(19) United States
(12) Patent Application Publication
(10) Pub. No.: US 2008/0000651 A1
(43) Pub. Date: Jan. 3, 2008

(54) PLUG AERATOR WITH FOLDABLE LIFT LEVER

(75) Inventor: Neil Edwin Bowsher, Sullivan, IL (US)

Correspondence Address: VEDDER PRICE KAUFMAN & KAMMHOLZ, 222 N. LASALLE STREET, CHICAGO, IL, 60601, US

(73) Assignee: AGRI-FAB, INC., Sullivan, IL (US)

(21) Appl. No.: 11/422,662

(22) Filed: Jun. 7, 2006

(51) Int. Cl. A01B 45/02

(52) U.S. Cl. 172/22

(57) ABSTRACT

The present disclosure relates generally to a plug aerator designed as a ground-engaging implement, and more particularly, to a plug aerator equipped with a multiposition lever where the lever is cleared from the weight stacking area in both engaged and disengaged configurations, and where the lever is placed substantially along a main shaft in a stored configuration. Plug aerator wheels are also placed under the main body portion between implements with plugs. The use of a notch pin on the disengaging system of the lever allows for a built-in safety protection of the disclosure against backlash from shocks and bumps while in operation.

### FIELD OF THE DISCLOSURE

The present disclosure relates generally to a plug aerator designed as a ground-engaging implement, and more particularly, to a plug aerator equipped with a multiposition lever where the lever is cleared from the weight stacking area in both engaged and disengaged configurations, and where the lever is placed substantially along a main shaft in a stored configuration.

### BACKGROUND

Soil aeration is a convention technique used by many gardeners and groundskeepers to reduce compaction in the soil, to stimulate plant growth, and to promote drainage within a chosen area. Understanding of localized compaction that translates into limited plant growth is best exemplified by a frequently traveled path across a large area of grass. The grass on the path loses surface vegetation because of excessive ground compaction. Planting new seeds or watering is often insufficient to return growth to proper levels. This is one of the numerous reason why soil must be aerated.

Several types of devices are used to aerate soil. In general, soil aerators have aeration tubes that penetrate the compacted ground to aerate by removing “plugs” of soil. Aeration tubes are typically carried on bars or racks affixed to a rotary member. Plug aerators may be installed on a main body with a tongue adapted to facilitate connection to a towing vehicle. These plug aerators are then pulled across a surface to aerate.

Plug aerators dragged or pulled must be of sufficient weight to remain on the ground and drive the aeration tubes into the ground, but the use of excessive weights in conjunction with these devices may result in bulky equipment that is difficult to store, handle, and operate without the towing vehicle. For this reason, some plug aerators contain a main body portion where weights can be stacked for use and removed afterward. As a consequence of weighting these devices, an auxiliary system of transportation must be devised to permit the plug aerators to disengage from the ground during transportation while loaded with weights.

The prior art shown as FIG. 1 illustrates one possible embodiment of such a plug aerator. This device is equipped with a flat, horizontal main body portion where weights serve as bascule. A lever is engaged and side wheels are rotated into position to engage or disengage the plug aerators from the soil. Operation of these devices may seem advantageous when the lever is disposed through the main body, but in fact, the presence of a long, thin, and vulnerable lever in a garden-type environment creates difficulties for long-term storage. If a user bends the lever, the device may become inoperable. In addition, a lever located in the middle of the weight storage section may also be vulnerable to shocks and prevent users from arranging selected weight across the main body surface.

Plug aerators are also subject to shocks during use and transportation, such as when the implement hits a rock or a curb. In the current configuration, if too much weight is placed in the main body portion while the system is disengaged, a shock may result in the permanent deformation of one of the mechanical components of the plug aerator.

Therefore, a need exists in the art for a ground-engaging implement, i.e., a plug aerator in one embodiment, that retains all the functionality of prior designs yet protects the lever from shock, allows users to better stack weight into the main body tray, and is equipped with a built-in safety system to minimize permanent deformation of mechanical components of the implement.

### SUMMARY

The present disclosure relates generally to a plug aerator designed as a ground-engaging implement, and more particularly, to a plug aerator equipped with a multiposition lever where the lever is cleared from the weight stacking area in both engaged and disengaged configurations, and where the lever is placed substantially along a main shaft in a stored configuration.

Plug aerator wheels are also placed under the main body portion between implements with plugs to optimize the effective workable width of a plug aerator towed behind a vehicle over the total width of the plug aerator. In addition, the presence of wheels in proximity to part of the implements removing plugs holds the soil in position while plugs are removed. The use of a notch pin on the disengaging system of the lever allows for a built-in safety protection of the disclosure against backlash from shocks and bumps while in operation.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a perspective view of a ground-engaging implement from the prior art in a disengaged configuration and showing in shadow an engaged configuration;

FIG. 2 is a quarter perspective side view of a ground-engaging implement with a foldable lift lever in a disengaged configuration in accordance with the teachings of the present disclosure;

FIG. 3 is a rear perspective partial view of the ground-engaging implement of FIG. 2 according to section 3-3 as shown on FIG. 2.

FIG. 4 is the ground-engaging implement of FIG. 2 where the foldable lift lever is in the engaged configuration;

FIG. 5 is rear perspective partial view of the ground-engaging implement of FIG. 4 according to section 5-5 as shown on FIG. 4; and

FIG. 6 is a perspective view of the ground-engaging implement in a storage configuration where part of the weight tray is removed to show the arm in the storage configuration.

### DETAILED DESCRIPTION

For the purposes of promoting and understanding the principles disclosed herein, reference are now made to the preferred embodiments illustrated in the drawings and specific language is used to describe the same. It is nevertheless understood that no limitation of the scope of the invention is thereby intended. Such alterations and further modifications in the illustrated device and such further applications of the principles disclosed as illustrated therein are contemplated as would normally occur to one skilled in the art to which this disclosure relates.

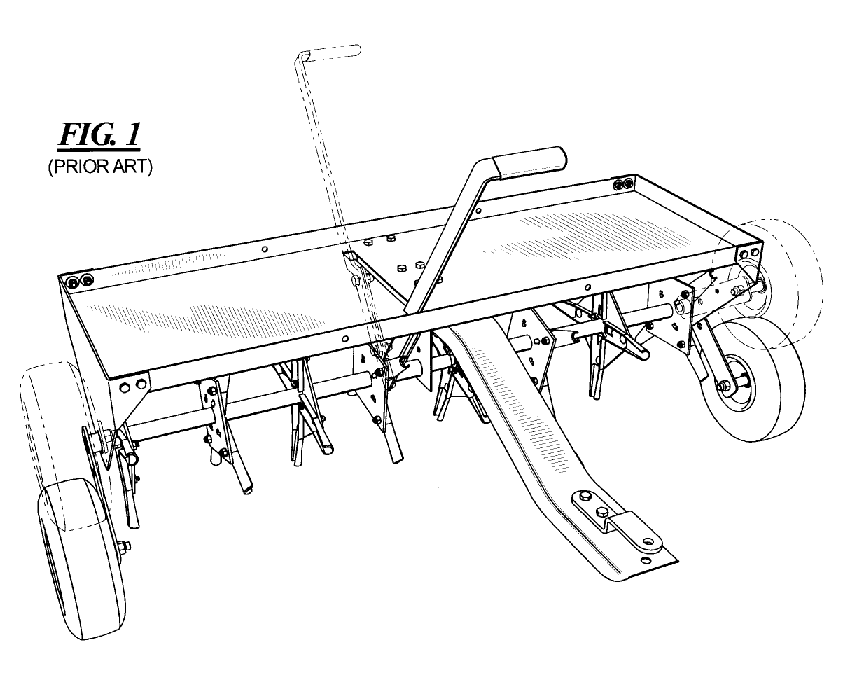

FIG. 1 is a perspective view of a ground-engaging implement from the prior art in a disengaged configuration. The figure also uses shadow lines to show the ground-engaging implement in an engaged configuration. To operate the plug aerators such as the invention of FIG. 1 or the present disclosure, a user first engages a lever (as shown) to place weights on the main body portion without fear of damaging the aeration mechanism under the main body. Wheels located offset from the main rotation axis rotate along with the lever to a position where only the wheels contact the ground. The user then places weights, such as hard metal sections, bags of sand, water drums, or any other available weight, on the surface available to the user. The ground-engaging implement is then moved to a location where soil aeration is desired using in a possible embodiment a towing vehicle. The lever is then moved from a first position to a second position. FIG. 1 illustrates in shadow such a second position where the wheels are rotated forward and the ground-engaging implements are able to contact the ground. It is understood by one of ordinary skill in the art that the correlation of the weight to be placed on the main body portion with the desired aeration in the soil is a function of experience, soil properties, and other such parameters known to one skilled in the art. Once the selected soil surface is aerated by translation of the implement, the lever is pushed back into the first position to disengage the ground-engaging implements from contact with the ground.

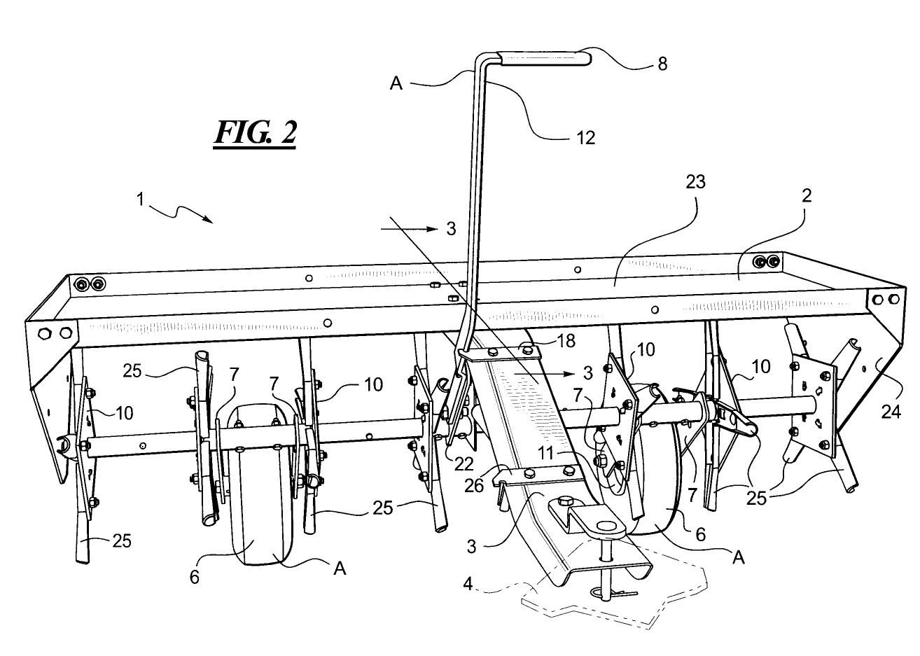

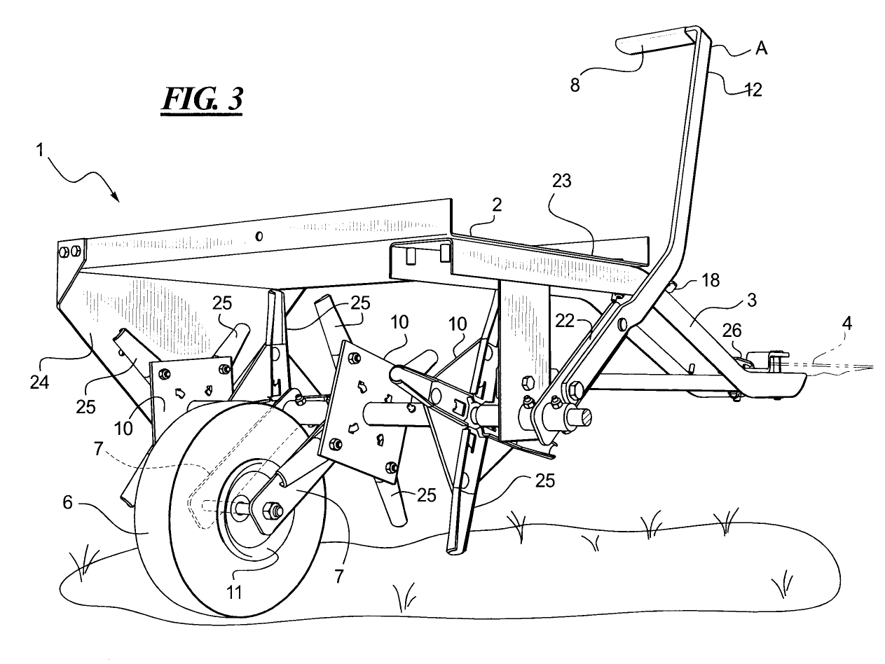

FIG. 2 shows a quarter perspective side view of a ground-engaging implement with a foldable lift lever in a disengaged configuration in accordance with the teachings of the present disclosure. FIG. 2 shows a ground-engaging implement 1 comprising a main body portion 2, including a tongue 3 adapted to facilitate connection to a towing vehicle 4 and extending from the main body portion 2. The ground-engaging implement also comprises a main shaft 60 shown on FIG. 3, movably connected to the main body 2, and includes tires 6 connected offset from the main shaft 60 by offset plates 7. In the disclosed embodiment, the main body 2 includes three vertical plates, the first two attached at each extremity of the main body 2 and the last in the center of the ground-engaging implement 1. The main shaft 60 as shown is a steel tube where a plurality of hollow tube sleeves 61 are slipped over the main shaft 60. The main shaft 60 is rotatably connected to the main body 2, and includes an arm 22 and offset plates 7 rigidly connected to the main shaft 60. When the arm 22 is moved around the main shaft axis, the wheels 6 are appropriately moved.

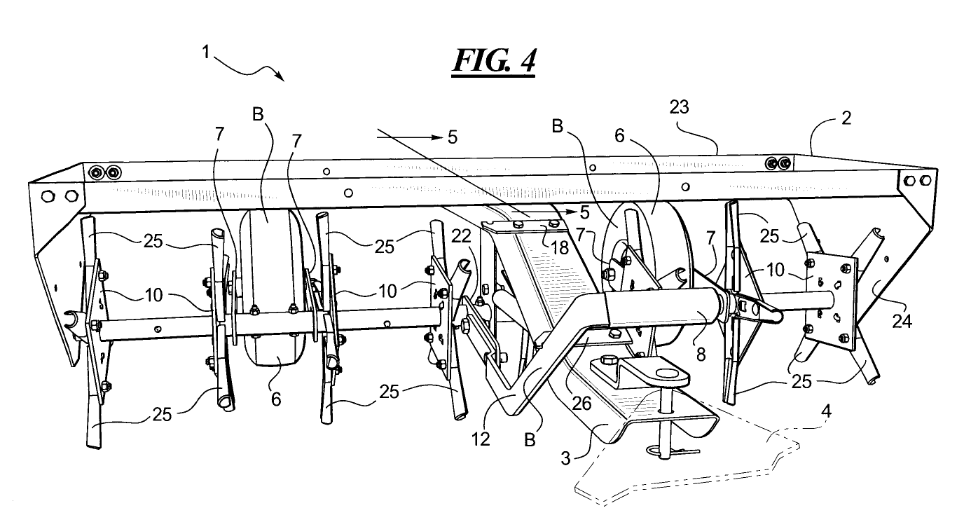

The main body 2 may also include a weight tray 23, shown on FIG. 2 as a flat, rectangular surface surrounded by a small ledge. In one preferred embodiment, the body is made of steel and the side plates are bolted to each side. The center plate is either welded or bolted to the center portion of the main body 2. Sleeves 61 are slipped over the main shaft 60 and include implements 10 connected thereon. The implement, in one embodiment, includes plug tubes 25, which are able to remove plugs of soil when engaged with the ground. The implements 10 and the sleeves 61 are disposed over the main shaft 60 and move freely with respect thereto such that in the operative position, shown as position B on FIG. 4, the implements 10 are adapted to engage the ground. The implement 10 and the sleeves 61 are also disposed over the main shaft so that in the inoperative position shown as position A on FIG. 2, the implements 10 are adapted to disengage the ground. The weight tray 23 is also made of metal sheeting of sufficient strength and thickness, and built with the proper reinforcements, if needed, to withstand pressure from weights placed on the tray 23 without leading to excessive deformation in the overall main body 2. While one possible embodiment of the main body 2 and supports is shown, it is understood by one of ordinary skill in the art that a large number of possible arrangements is possible based on mechanical design considerations.

The tongue 3 as shown on FIG. 2 is made of a double bent C section profile of steel bolted to the main body 2 at a first end by a series of eight bolts and at the other end by a towing connection mechanism as commonly used to attach towed implements to towing vehicles 4. The towing connection mechanism as illustrated is a vertical fixation axis bent as an offset clamp with a rotational joint and a fixation pin. While a possible fixation system of the tongue 3 is illustrated at each end of the tongue 3, it is understood by one of ordinary skill in the art that both ends of the tongue 3 may be attached using any possible method of fixation as long as the towing vehicle is able to functionally pull the ground-engaging implement 1 along the direction of utilization.

An arm 22 is securely connected to the main shaft 60 and allows movement of the main shaft 60 between an operative position, shown as position B on FIG. 4, and an inoperative position, shown as position A on FIG. 2. A lift lever 12, including a mounting end 50 and an operative end 8, is used to rotate the main shaft 60 between the operative position and the inoperative position. The mounting end 50 is connected to the arm 22 at a first location 51 adjacent to the main shaft 60 and is removably connected at a second location 52 located between the first location 51 and the operative end 8.

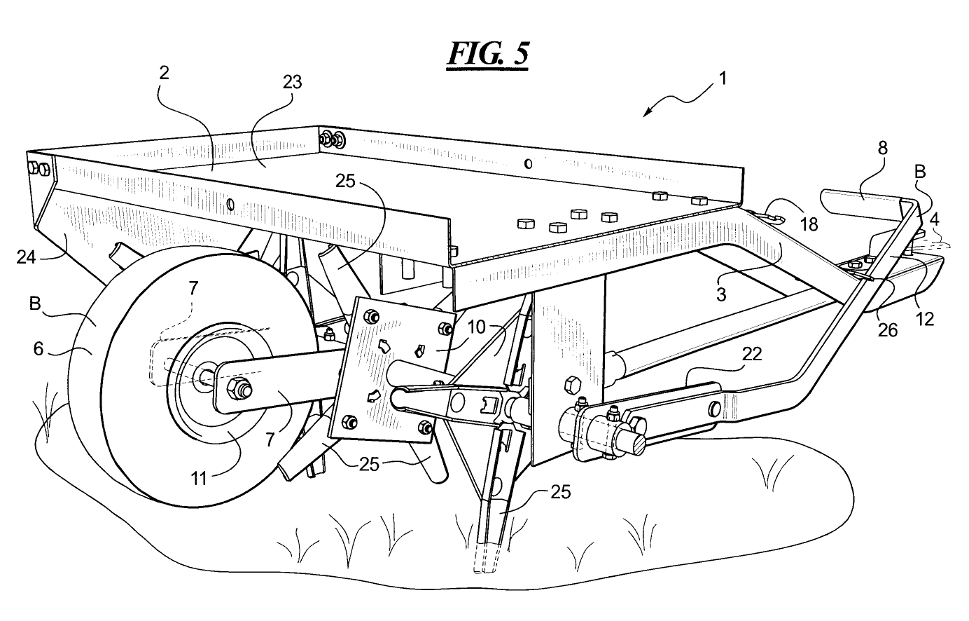

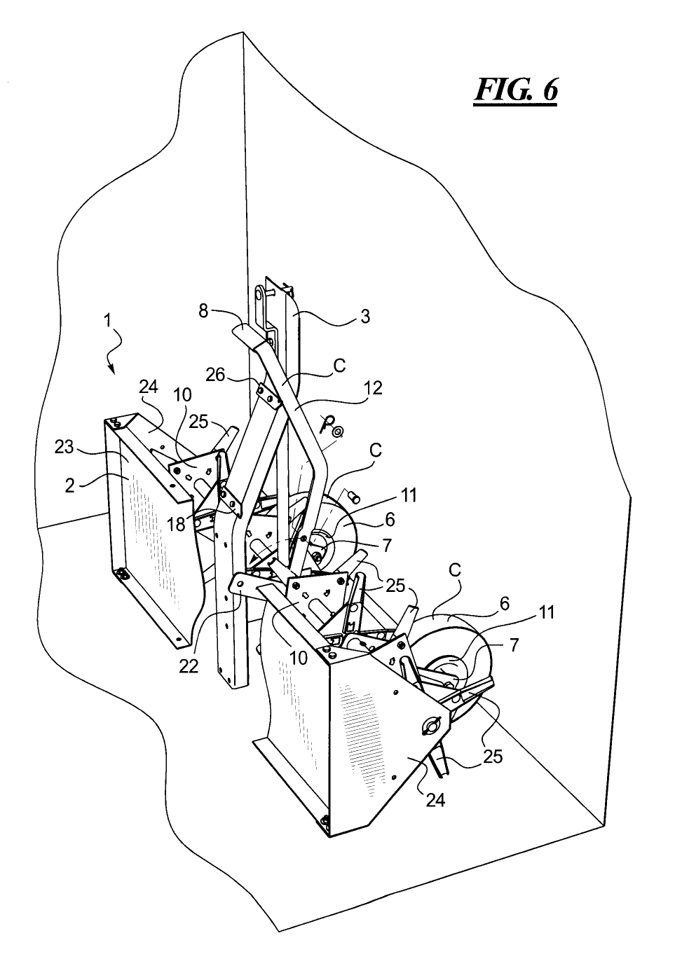

FIGS. 2-3 show a first position of a first embodiment where the lift lever 12 may be connected at the second location 52 to the arm 22 while the lift lever 12 extends in a direction different from the main direction of the tongue 3. FIGS. 4-5 show a second position of a first embodiment where the lift lever 12 may be connected at the second location 52 to the arm 22 while the lift lever 12 extends in substantially the same direction as the tongue 3. FIG. 6 shows a third position of a first embodiment where the lift lever 12 is not connected at the second location 52 to the arm 22 while the lift lever 12 extends in a direction substantially the same direction as the tongue 3 but the arm 22 extends in different direction from the direction of the lift lever 12.

In the embodiment shown in FIGS. 2-6, the lift lever 12 is disposed below the weight tray 23 in the three possible configurations. In another embodiment, the first location 51 is a pivotal connection. In yet another embodiment, the lift lever 12 is held in the operative position by a first notch plate 26 and is held to the inoperative position by a second notch plate 18. One of ordinary skill in the art understands that the notch plates 26, 18 as shown may include notches of sufficient size to house the lift lever 12. It is also understood that while a notch mechanism is disclosed, the notch plates serve as a mechanical stop system that limit the angular rotation displacement and the associated rattling of the lift lever 12 and that a plurality of other systems may be implemented to hold the lift lever 12 in two distinct positions along the tongue 3. In one embodiment, only notch plate 18 is used and required to maintain the disengaged position.

FIG. 6 is a perspective view of the ground-engaging implement in a storage configuration where part of the weight tray is removed to show the arm in the storage configuration illustrated as C. In this configuration, a locking pin 70 and the associated counter-lock pin 71 to allow the arm 22 to disengage from the lift lever 12. The lift lever 12 is stored in the storage configuration C and shown placed under the first notch plate 26. In the preferred embodiment, the lift lever 12 may be placed along the tongue 3 without the use of the first notch plate 26.

FIGS. 2-6 show an implement 10 made of a square shaped plate with four tubes acting as plug aerators 25 are attached by a bolt to each corner of the square plate. FIGS. 2-6 also show angular corner plates 80 used to reinforce the perpendicular connection between the horizontal weight tray 23 and the vertical side plates. FIGS. 2-6 further disclose a ground-engaging implement 1 that has a first wheel 6 located between the third and the fourth implements 10, and a second wheel 6 located between the sixth and the seventh implements 10. In the preferred embodiment, the ground-engaging implement 1 is shown with a total of eight implements 10, but it is understood by one of ordinary skill in the art that the number and position of implements 10 and the number and position of the wheels 6 may be varied.

Furthermore, while the particular preferred embodiments have been shown and described, it is obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A ground-engaging implement comprising:
a main body portion including a tongue adapted to facilitate connection to a towing vehicle and extending from the main body portion;
a main shaft movably connected to the main body including tires connected offset to the main shaft adapted for engaging the ground;
an arm securely connected to the main shaft to facilitate movement of the main shaft between an operative position and an inoperative position;
implements connected to a sleeve disposed over the main shaft and freely movable with respect thereto such that in the operative position the implements are adapted to engage the ground;
a lift lever including a mounting end and an operative end such that the mounting end is connected to the arm at a first location adjacent to the main shaft and removably connected at a second location between the first location and the operative end and wherein the lift lever when connected at the second location to the arm extends in the same direction as the tongue when the main shaft is in the operative position and wherein the lift lever when disconnected at the second location extends in the same direction as the tongue when the main shaft is in the storage position.

2. The implement as recited in claim 1, wherein the main body portion includes a weight tray.

3. The implement as recited in claim 2, wherein the lift lever is disposed below the weight tray.

4. The implement as recited in claim 1, wherein the implement is a plug aerator.

5. The implement as recited in claim 1, wherein the first location connection is pivotal.

6. The implement as recited in claim 1, wherein the lift lever is held to position the main shaft at the operative and non operative positions by notch plates.

7. A plug aerator comprising:
a main body portion defining a weight tray and depending supports and including a tongue adapted to facilitate connection to a towing vehicle wherein the tongue extends substantially normal from the weight tray;
a main shaft movably connected to the supports of the main body and including tires connected offset to the main shaft that are adapted for engaging the ground;
an arm secured to the main shaft to translate movement thereof to the main shaft between an operative position and an inoperative position wherein the arm extends in the direction of the tongue in the operative position and extends other than the direction of the tongue in the inoperative position;
plug aerators connected to a sleeve disposed over the main shaft and freely movable with respect thereto such that in the operative position the plug aerators are adapted to engage the ground;
a lift lever including a mounting end and an operative end such that the mounting end is connected to the arm at a first location adjacent the main shaft and removably connected at a second location between the first location and the operative end wherein lift lever extends in the same direction as the tongue when the main shaft is disposed in the storage position as a result of the lift lever being disconnected from the arm at the second location.

8. The implement as recited in claim 2, wherein the lift lever is disposed below the weight tray.

9. The implement as recited in claim 1, wherein the first location connection is pivotal.
